(19) United States
(12) Patent Application Publication
(10) Pub. No.: US 2004/0155766 A1
(43) Pub. Date: Aug. 12, 2004

(54) Apparatus for indicating signals for vehicles

(76) Inventor: Yong Lee, Seoul (KR)

Correspondence Address: LADAS & PARRY, 224 SOUTH MICHIGAN AVENUE, SUITE 1200, CHICAGO, IL, 60604, US

(21) Appl. No.: 10/761,822

(22) Filed: Jan. 21, 2004

(30) Foreign Application Priority Data
Jan. 30, 2003 (KR) 20-2003-0003004

(51) Int. Cl. B60Q 1/26

(52) U.S. Cl. 340/468; 340/464

(57) ABSTRACT

An apparatus for indicating signals for vehicles is provided, which includes: a U-turn indicating light which is connected to a U-turn indication contact and provided in the front and rear side of a vehicle; a left-side direction light which is connected to a left-side direction indication contact and provided in the front and rear side of one side in the vehicle; a right-side direction light which is connected to a right-side direction indication contact and provided in the front and rear side of the right-side in the vehicle; a switch lever which is selectively connected to the U-turn indication contact, the left-side direction indication contact, and the right-side direction indication contact, and selectively applies electric power to the U-turn indication light, the left-side direction light, and the right-side direction light; a power source for supplying power to the switch lever; an emergency indication light which is provided in the front and rear side of the other side in the vehicle to receive the power from the power source to notify an emergency state in the vehicle externally; and an emergency indication light switch which is provided between the power source and the emergency indication light, to open and close the power source which supplies power to be applied to the emergency indication light. Thus, traffic accidents can be reduced by U-turn indication which is notified externally from the vehicle. Also, when the vehicle has been robbed by a burglar or burglars, an emergency situation that a driver is threatened can be notified externally from the vehicle.

### BACKGROUND OF THE INVENTION

1. Field of the Invention

The present invention relates to an apparatus for indicating signals for vehicles, and more particularly, to an apparatus for indicating signals for vehicles, including a U-turn indication light and an emergency indication light in addition to a left-side direction indication light and a right-side direction indication light, in order to notify persons who are outside of a vehicle of an emergency situation of a driver in the vehicle as well as to prevent safety accidents of the vehicle in advance.

2. Description of the Related Art

In general, a lane allowing a U-turn and a left turn or a lane allowing only a left turn is provided on a cross street of a four-lane or more. Thus, a vehicle which intends to make a U-turn should proceed along a first lane allowing a left turn or stand by a left turn signal at the first lane, and a vehicle which intends to make a left turn should proceed along a first lane allowing a U-turn and a left turn and a second lane allowing only a left turn or stand by a left turn signal at the first lane or the second lane.

Here, a driver of a vehicle which stands by the U-turn signal or left turn signal should make a left-side direction indication light operate, to thereby notify vehicles at the other side or the rear side of his or her proceeding direction.

However, under the assumption that a vehicle at the front side stands by a U-turn signal at a lane allowing a U-turn and left turn and another vehicle stands by a left turn signal, if a left turn signal is lit at a traffic signal light, the rear-side vehicle may not grasp the proceeding direction of the front-side vehicle, and thus rear-end collision traffic accidents may happen frequently.

That is, since the front-side vehicle which stands by a U-turn signal flickers only a left-side direction indication light simply in the same way as a left turn standby vehicle, the rear-side vehicle cannot grasp whether the front-side vehicle will make a left turn or U-turn. Accordingly, if a left turn signal is lit at a traffic signal light, the rear-side vehicle may make a rear-end collision with the front-side vehicle which reduces speed in order to make a U-turn.

FIG. 5 shows situations of vehicles which may happen in a general cross street, and FIG. 6 shows situations of vehicles which may happen in a cross street on which a barrier 4 is installed. As illustrated in FIGS. 5 and 6, a vehicle 3 at the other side or a vehicle 2 at the rear side may induce traffic accidents frequently with a vehicle 1 which stands by a U-turn signal, unless the driver of the vehicle 3 or 2 realizes that the vehicle 1 will make a U-turn.

Also, when a burglar disguising as a passenger may get in a taxi, a taxi driver needs to notify an emergency situation that a possible burglar got in the taxi. However, in the case that a manual signal using the driver's hands is sent or an emergency light is lit, the other persons who are outside of the vehicle may not grasp what the manual signal or emergency light signal is. Also, such a signal transferring action may be easily prohibited by the burglar.

### SUMMARY OF THE INVENTION

To solve the above problems, it is an object of the present invention to provide an apparatus for indicating signals for vehicles, including a U-turn indication light and an emergency indication light in a conventional signal indicating apparatus for a vehicle, in order to notify persons who are outside of a vehicle of declaration of intention of a U-turn or an emergency situation of a driver in the vehicle.

To accomplish the above object of the present invention, there is provided an apparatus for indicating signals for vehicles, comprising: a U-turn indicating light which is connected to a U-turn indication contact and provided in the front and rear side of a vehicle; a left-side direction light which is connected to a left-side direction indication contact and provided in the front and rear side of one side in the vehicle; a right-side direction light which is connected to a right-side direction indication contact and provided in the front and rear side of the right-side in the vehicle; a switch lever which is selectively connected to the U-turn indication contact, the left-side direction indication contact, and the right-side direction indication contact, and selectively applies electric power to the U-turn indication light, the left-side direction light, and the right-side direction light; a power source for supplying power to the switch lever; an emergency indication light which is provided in the front and rear side of the other side in the vehicle to receive the power from the power source to notify an emergency state in the vehicle externally; and an emergency indication light switch which is provided between the power source and the emergency indication light, to open and close the power source which supplies power to be applied to the emergency indication light.

Here, the one side and the other side of the vehicle are determined by a traffic rule of vehicles which is varied according to countries. In the case of Republic of Korea which puts the right-side passing of vehicles in operation, the U-turn indication light should be provided in the front or rear side at the left side in each vehicle. In the case of countries which puts the left-side passing of vehicles in operation, the U-turn indication light should be provided in the front or rear side at the right side in each vehicle.

Here, it is preferable that the emergency indication light is incorporated in the switch lever and thus the emergency indication contact is selectively connected to the switch lever together with the U-turn indication contact, the left-side direction indication contact, and the right-side direction indication contact. Thus, drivers can manipulate the U-turn indication light and the emergency indication light by manipulating the switch lever.

Here, it is preferable that the emergency indication light switch is positioned at a position where a foot of the driver of the vehicle reaches. This is because the feet of the driver move often in order to shift gears, or accelerate or decelerate speed of the vehicle even in the case that the driver's actions are not freely accepted by the burglar, and thus the switch manipulation by the driver's foot or feet is not easily exposed to the burglar.

### BRIEF DESCRIPTION OF THE DRAWINGS

The above and other objects and advantages of the present invention will become more apparent by describing the preferred embodiments thereof in more detail with reference to the accompanying drawings in which:

FIG. 1 is a circuitry diagram of a signal indication apparatus for a vehicle according to a first embodiment of the present invention;

FIG. 2 is a circuitry diagram of a signal indication apparatus for a vehicle according to a second embodiment of the present invention;

FIG. 3 is a front view showing a left-side tail light of a vehicle;

FIG. 4 is a front view showing a right-side tail light of a vehicle;

FIG. 5 shows situations of vehicles which may happen in a general cross street; and

FIG. 6 shows situations of vehicles which may happen in a cross street on which a barrier is installed.

### DETAILED DESCRIPTION OF THE INVENTION

Preferred embodiments of the present invention will be described with reference to the accompanying drawings.

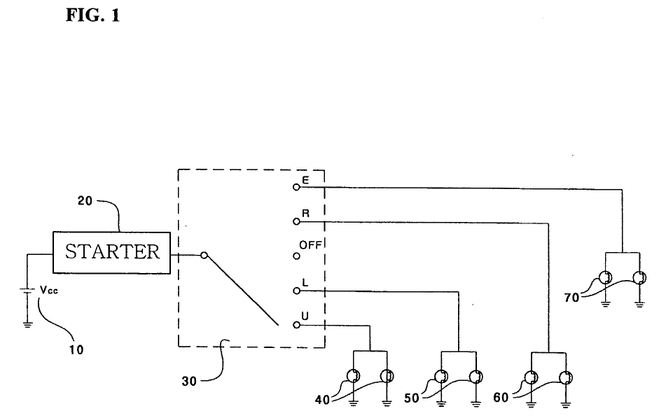

FIG. 1 is a circuitry diagram of a signal indication apparatus for a vehicle according to a first embodiment of the present invention.

Referring to FIG. 1, an apparatus for indicating signals for a vehicle according to a first embodiment of the present invention will be described below.

A power source 10 is a conventional battery in a vehicle.

A starter 20 is provided between the power source 10 and a switch lever 30. Thus, if a vehicle is started by the starter 20, electric power is applied from the power source 10 to the switch lever 30. Here, the structure of the starter 20 is nothing but an exemplary embodiment. That is, without using such a starter 20, the power source 10 can be connected directly to the switch lever 30. Also, another configurational element can be added between the power source 10 and the switch lever 30.

The switch lever 30 can be connected selectively to a U-turn indication contact which is connected to a U-turn indication light 40 including the front-side U-turn indication lamps, a left turn indication contact which is connected to a left turn indication light 50 including the front-side left turn indication lamps, a right turn indication contact which is connected to a right turn indication light 60 including the front-side right turn indication lamps, and an emergency indication contact which is connected to an emergency indication light 70 including the front-side emergency indication lamps.

The switch lever 30 is installed in a conventional steering column (not shown) in the vehicle.

Thus, drivers can manipulate the switch lever 30 to notify persons who are outside of the vehicle of an intention of a U-turn or an emergency situation in the vehicle.

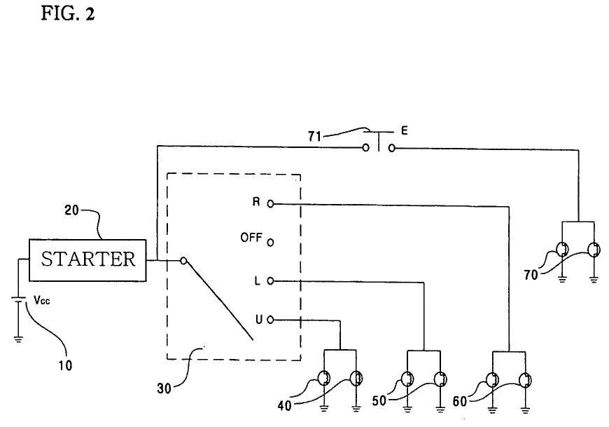

FIG. 2 is a circuitry diagram of a signal indication apparatus for a vehicle according to a second embodiment of the present invention.

Referring to FIG. 2, an apparatus for indicating signals for a vehicle according to a second embodiment of the present invention will be described below.

The FIG. 2 circuit differs from the FIG. 1 circuit. That is, the other elements of FIG. 2 are same as those of FIG. 1, excepting that an emergency indication light switch 71 which opens or closes power for an emergency indication light 70 including the front-side and rear-side lamps is separated from a switch lever 30 in FIG. 2.

Thus, the switch lever 30 of FIG. 2 can be also connected selectively to a U-turn indication contact which is connected to a U-turn indication light 40 including the front-side U-turn indication lamps, a left turn indication contact which is connected to a left turn indication light 50 including the front-side left turn indication lamps, and a right turn indication contact which is connected to a right turn indication light 60 including the front-side right turn indication lamps.

Here, it is preferable that the emergency indication light switch 71 is positioned at a secret portion where a driver's foot can reach. This is because a driver's action of indicating an emergency signal can be hidden to a burglar.

Also, it is preferable that the emergency indication light switch 71 is positioned in a different position of each vehicle. This is because a burglar who knows where such an emergency indication light switch 71 exists can interrupt the driver from manipulating the emergency indication light switch if the installation positions of the emergency indication light switches 71 are standardized.

In this embodiment, the emergency indication light switch 71 should be positioned at a position where it would not be nearly manipulated by mistake, and can be manipulated only by a secret manipulation of each driver.

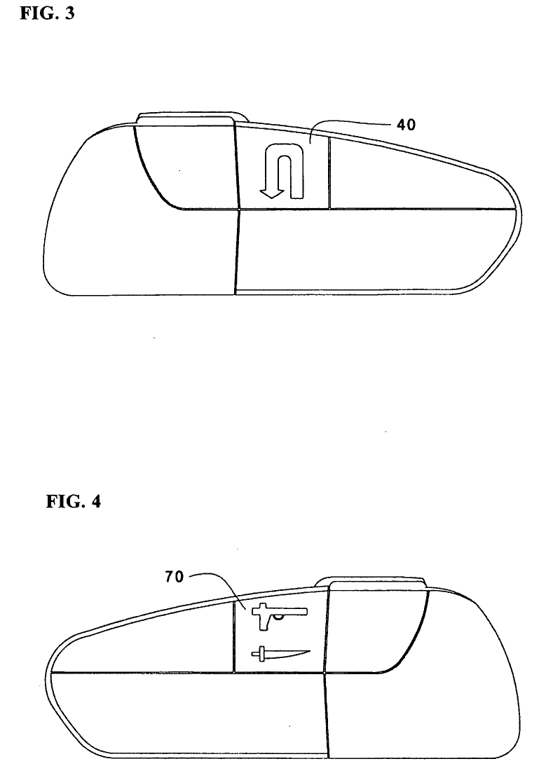

FIG. 3 is a front view showing a left-side tail light of a vehicle, in which an external appearance of a U-turn indication light 40 is illustrated.

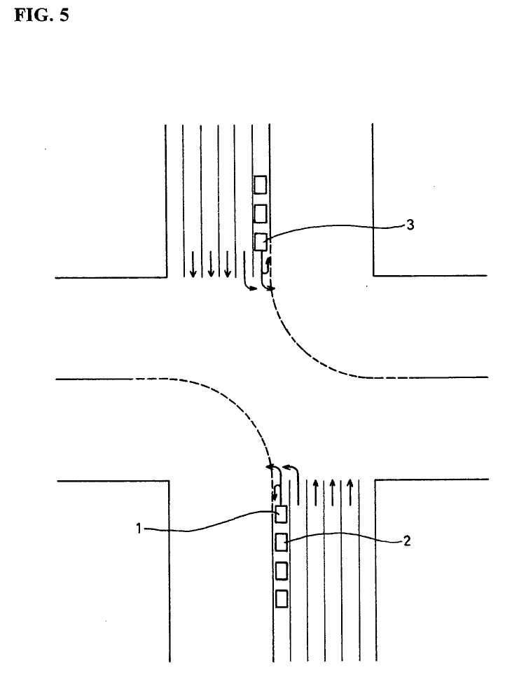

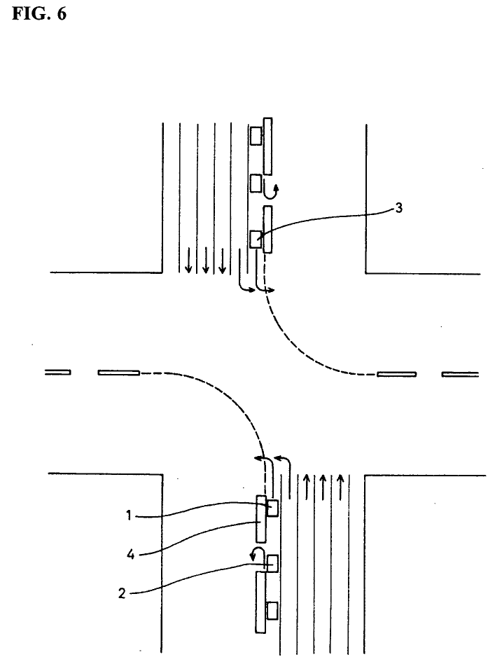

FIG. 4 is a front view showing a right-side tail light of a vehicle, in which an external appearance of an emergency indication light 70 is illustrated.

It is preferable that color lamps of green, yellow green or blue should be used as the U-turn indication light 40. In contrast, red color lamps are preferably used as the emergency indication light 70.

As described above, the present invention provides the apparatus for indicating signals for vehicles, to thereby reduce traffic accidents by U-turn indication which is notified externally from the vehicle. Also, when the vehicle has been robbed by a burglar or burglars, an emergency situation that a driver is threatened can be notified externally from the vehicle. Also, even in the case that such an emergency situation does not happen, drivers can drive vehicles more comfortably with a feeling of relief that emergency situations which may happen in the vehicles can be notified externally to persons who are outside of the vehicles.

As described above, the present invention has been described with respect to particularly preferred embodiments. However, the present invention is not limited to the above embodiments, and it is possible for one who has an ordinary skill in the art to make various modifications and variations, without departing off the spirit of the present invention.

What is claimed is:

1. An apparatus for indicating signals for vehicles, comprising:
a U-turn indicating light which is connected to a U-turn indication contact and provided in the front and rear side of a vehicle;
a left-side direction light which is connected to a left-side direction indication contact and provided in the front and rear side of one side in the vehicle;
a right-side direction light which is connected to a right-side direction indication contact and provided in the front and rear side of the right-side in the vehicle;
a switch lever which is selectively connected to the U-turn indication contact, the left-side direction indication contact, and the right-side direction indication contact, and selectively applies electric power to the U-turn indication light, the left-side direction light, and the right-side direction light;
a power source for supplying power to the switch lever;
an emergency indication light which is provided in the front and rear side of the other side in the vehicle to receive the power from the power source to notify an emergency state in the vehicle externally; and
an emergency indication light switch which is provided between the power source and the emergency indication light, to open and close the power source which supplies power to be applied to the emergency indication light.

2. The apparatus for indicating signals for vehicles of claim 1, wherein the emergency indication light is incorporated in the switch lever and thus the emergency indication contact is selectively connected to the switch lever together with the U-turn indication contact, the left-side direction indication contact, and the right-side direction indication contact.

3. The apparatus for indicating signals for vehicles of claim 1, wherein the emergency indication light switch is positioned at a position where a foot of the driver of the vehicle reaches.
